(19) United States
(12) Patent Application Publication
(10) Pub. No.: US 2025/0206085 A1
(43) Pub. Date: Jun. 26, 2025

(54) HANDTOOL FOR CHANGING BICYCLE TYRES

(71) Applicant: TRU TENSION LTD, Blackwell (GB)

(72) Inventor: Chris Frappell, Nailsea (GB)

(21) Appl. No.: 19/078,930

(22) Filed: Mar. 13, 2025

Related U.S. Application Data
(63) Continuation of application No. PCT/EP2023/075106, filed on Sep. 13, 2023.

(30) Foreign Application Priority Data
Sep. 13, 2022 (GB) 2213396.1

(51) Int. Cl. B60C 25/04

(52) U.S. Cl. CPC B60C 25/04

(57) ABSTRACT

In some examples, a tool for fitting and removing a tyre on a wheel rim comprises an elongate body forming a handle for the tool, wherein the elongate body is generally planar in form, having a plane and a longitudinal axis, a tyre-engagement portion arranged to, in use, engage with an outer side wall of the tyre to thereby facilitate fitting of the tyre, the tyre-engagement portion having a plane which is co-planar with the plane of the elongate body, and a hook portion, orthogonal to the longitudinal axis of the elongate body, arranged to, in use, engage with an inner side wall of the tyre to thereby facilitate removal of the tyre.

### PRIORITY

This application is related to, claims the priority benefit of, and is a bypass continuation of International Patent Application No. PCT/EP2023/075106 filed Sep. 13, 2023, which is related to and claims the priority benefit of GB Patent Application No. 2213396.1 filed Sep. 13, 2022. The contents of the aforementioned applications are incorporated herein by reference in their entireties.

### TECHNICAL FIELD

The present invention relates to tools for fitting bicycle tyres on bicycle wheel rims and/or removing bicycle tyres from bicycle wheel rims.

### BACKGROUND

As part of bicycle maintenance and repair, fitting bicycle tyres on and removing bicycle tyres from wheel rims may be performed. Depending on the type of tyre and the wheel rim on which the tyre is installed on or is to be removed from, the ease of fitting/removal from the wheel rim can vary greatly depending on the type of tyre used and how tightly the tyre sits on the wheel rim. Often, a tool such as a tyre lever may be used to aid a user in lifting the tyre bead and the corresponding section of the tyre side wall over the wheel rim during fitting or removal of the tyre.

For example, when fitting the tyre onto the wheel rim, a tyre lever may be used to ease the tyre over the side wall of the rim, as well as to ensure the correct positioning of the tyre being fitted. During removal of the tyre from the wheel rim, the lever may be placed between the wheel rim and the tyre bead to separate the tyre wall from the wheel rim and lift a section of the tyre bead over the side wall of the rim.

Existing solutions are associated with several disadvantages, ranging from complexity of the tool and therefore its ease of use, high cost, and/or difficulty during installation/removal of the tyre. It is therefore an object of the present invention to provide the user with a simple, robust tool to facilitate the fitting and removal of the tyre without damaging it in the process.

### SUMMARY OF INVENTION

An objective of the present disclosure is to provide a tool for fitting and removing a tyre on a wheel rim.

The foregoing and other objectives are achieved by the features of the independent claims.

Further implementation forms are apparent from the dependent claims, the description and the Figures.

A first aspect of the present disclosure provides a tool for fitting and removing a tyre on a wheel rim, the tool comprising an elongate body forming a handle for the tool, wherein the elongate body having a plane and a longitudinal axis, a tyre-engagement portion arranged to, in use, engage with an outer side wall of the tyre to thereby facilitate fitting of the tyre, the tyre-engagement portion having a plane which is co-planar with the plane of the elongate body, and a hook portion, orthogonal to the longitudinal axis of the elongate body, arranged to, in use, engage with an inner side wall of the tyre to thereby facilitate removal of the tyre.

Accordingly, a simple, inexpensive tool for fitting and removing a tyre on a wheel rim can be provided. Due to the orthogonal arrangement of the hook portion with respect to the elongate body serving as a handle, the problem of the user hitting their hands on the wheel spokes during maintenance of a bike or a similar vehicle can averted.

In an implementation of the first aspect, the hook portion further comprises a protrusion located at a rear portion of the hook portion, the protrusion arranged to, in use, engage with a side wall of the wheel rim to thereby keep the tool in place during removal of the tyre. Thus, the tool can stay in place during removal of the tyre, as the user applies pressure.

The tool may further comprise comprising a channel formed in a lateral axis of the elongate body, the channel arranged to, in use, receive a side wall of the wheel rim.

The channel may further comprise a lip arranged to, in use, engage with an inner portion of the side wall of the wheel rim. Thus, the tool can be kept in place during installation of the tyre.

The tyre-engagement portion may comprise a substantially flat surface.

The elongate body may comprise an aperture. Thus, the tool can be stored easily, for example on a hook.

The elongate body may comprise a plurality of structural support elements. Thus, the user can apply pressure safely, with the risk of the tool breaking being minimised.

The elongate body may be generally planar in form.

In some embodiments, the tool may be cast of metal or moulded from a resilient polymeric material. In other embodiments, the elongate body may be an elongate metal body and may include a polymeric material overmoulded to the metal body.

A second aspect of the present disclosure provides a method for removing a tyre from a wheel rim using the tool described herein, the method comprising pushing the hook portion underneath part of a tyre bead so that the tyre bead is lifted and the hook portion is located between the tyre bead and the wheel rim, moving the tool circumferentially around the wheel rim to thereby remove the tyre, wherein, during the removal, the tool is arranged at substantially 90 degrees to the tyre.

Accordingly, due to the orthogonal arrangement of the hook portion with respect to the elongate body serving as a handle, the problem of the user hitting their hands on the wheel spokes during maintenance of a bike or a similar vehicle can averted.

A third aspect of the present disclosure provides a method for fitting a tyre on a wheel rim using the tool described herein. the method comprising placing the tyre over a wheel rim wall so that a first side wall of the tyre is whole seated in a channel of the wheel rim, positioning the tool over the wheel rim wall such that the tyre-engagement portion engages a second side wall of the tyre, moving the tool circumferentially around the wheel rim to thereby fit the second side wall of the tyre in the channel of the wheel rim, wherein, during the fitting, the tool is arranged at substantially 90 degrees to the tyre.

Accordingly, due to the orthogonal arrangement of the hook portion with respect to the elongate body serving as a handle, the problem of the user hitting their hands on the wheel spokes during maintenance of a bike or a similar vehicle can averted.

These and other aspects of the invention will be apparent from the embodiment(s) described below.

### BRIEF DESCRIPTION OF THE DRAWINGS

In order that the present invention may be more readily understood, embodiments of the invention will now be described, by way of example, with reference to the accompanying drawings, in which:

FIG. 1 is a view of a side of the tool according to an embodiment of the present invention;

FIG. 2 is a perspective view of the tool of FIG. 1;

FIG. 3 is the tool of FIG. 1 as viewed from above;

FIG. 4 is the tool of FIG. 1 as viewed from below;

FIG. 5 depicts the tool of FIG. 1 in use during fitting of a tyre on a wheel rim;

FIG. 6 depicts the tool of FIG. 1 in use during removal of a tyre from a wheel rim;

FIG. 7 is a view of a side of the tool according to another embodiment of the present invention;

FIG. 8 is a perspective view of the tool of FIG. 7;

FIG. 9 is the tool of FIG. 7 as viewed from above.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

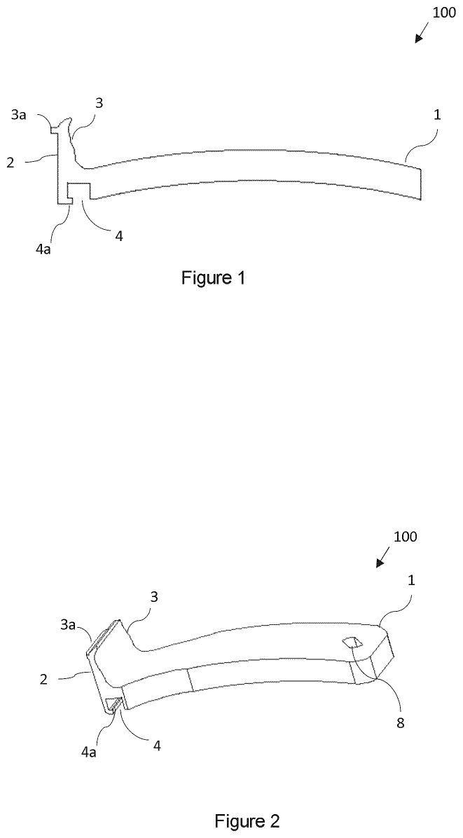

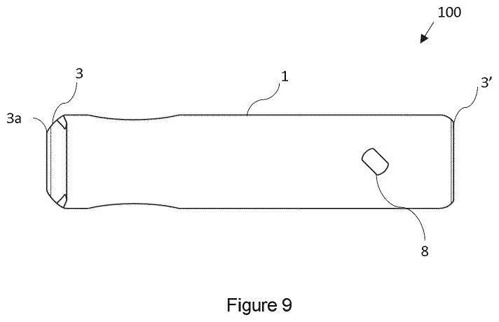

Referring to FIGS. 1-9, there is shown a tool according to an embodiment of the present invention.

The tool 100 comprises an elongate body 1, forming a handle for the tool 100. The elongate body 1 has a plane and a longitudinal axis. The elongate body 1 may be generally planar in form. In some embodiments, a cross-section of the elongate body 1 may be substantially circular.

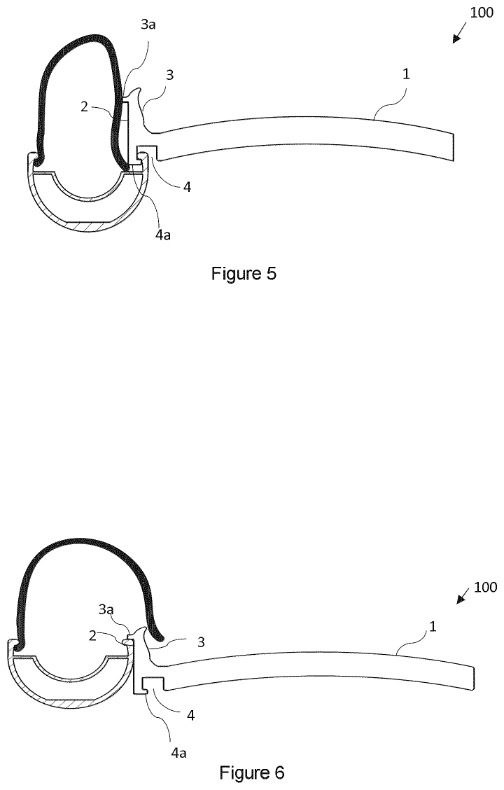

The tool 100 comprises a tyre-engagement portion 2 having a first side arranged to, in use, engage with an outer side wall of the tyre to thereby facilitate fitting of the tyre, as shown in FIG. 5. The tyre-engagement portion 2 has a plane which is co-planar with the plane of the elongate body 1. In an example, the plane of the tyre-engagement portion 2 may be substantially perpendicular to the longitudinal axis of the elongate body 1.

The tool 100 may be made from any material of suitable strength, for example plastics material or metal. The tool 100 may be formed as a unitary component. The tool 100 may also be manufactured in separate units/modules attachable to the body.

The tool 100 comprises a hook portion 3, orthogonal to the longitudinal axis of the elongate body 1. The hook portion 3 is arranged to, in use, engage with an inner side wall of the tyre to thereby facilitate removal of the tyre, as shown in FIG. 6. Advantageously, this allows the tool 100 to, in use, facilitate removal (or, indeed, installation/replacement) of the tyre while being arranged at 90 degrees to the wheel. This minimises the risk of a user hitting their hands on the spokes during removal. This is in contrast to the solutions currently available on the market, which are used at 180 degrees to the wheel.

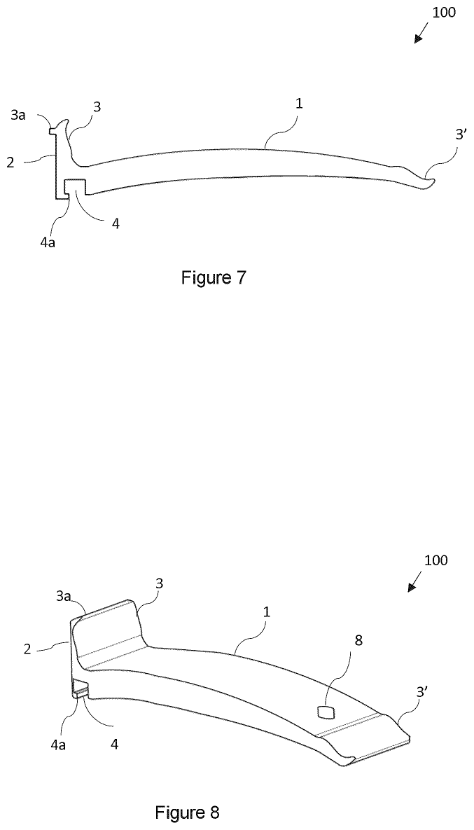

As depicted in FIGS. 7-9, the tool 100 may comprise a second hook portion 3′, in addition to the hook portion 3. The second hook portion 3′ may be identical in purpose to the hook portion 3. That is, the second hook portion 3′ may also be arranged to, in use, engage with the inner side wall of the tyre to thereby facilitate removal of the tyre. Similar to the hook portion 3, the second hook portion 3′ may be orthogonal to the longitudinal axis of the elongate body 1.

The hook portion 3 may comprise a protrusion 3a, located at a rear section of the hook portion 3. The protrusion 3a may be arranged to, in use, engage with a wall of the wheel rim to thereby keep the tool 100 in place during removal of the tyre. Referring to FIG. 5, the protrusion 3a may sit on top of a side wall of the wheel rim to prevent the tool 100 from slipping out as the user applies pressure, which is a common problem with currently available tools.

The tool 100 may comprise a channel 4, or a recess, formed in the elongate body 1. The channel 4 may be formed in a lateral axis of the elongate body 1. In some examples, the channel 4 may be located, or formed, between the tyre-engagement portion 2 and the elongate body 1. The channel 4 may be substantially U-shaped.

The channel 4 may assist in fitting of the tyre by receiving a side wall of the wheel rim, as shown in FIG. 5. The channel 4 may comprise a lip 4a arranged to, in use, engage with an inner section of the side wall of the wheel rim to thereby keep the tool 100 in place. The lip 4a may also serve as guiding means to improve the ease of fitting a tyre on a wheel rim. The lip 4a may have a plane that is co-planar with the plane of the elongate body 1.

The tyre-engagement portion 2 may be plate-like in shape, i.e. substantially flat. The tyre-engagement portion 2 may be arranged to, in use, contact the tyre to thereby position the tyre correctly within the wheel rim for the wheel rim to securely receive it.

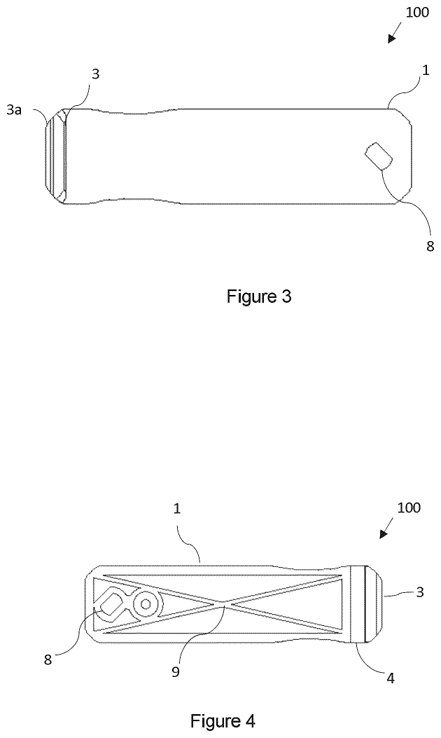

As shown in FIGS. 3 and 4, the tool 100 may comprise an aperture 8 in the elongate body 1. The aperture 8 may aid the user in storing the tool 100 in a neat manner, for example by hanging it onto a hook. Referring to FIG. 4, the tool 100 may further comprise a plurality of structural support elements 9, to thereby strengthen the elongate body 1, i.e. the handle held by the user in use. The support elements 9 may vary in shape and location.

Use of the invention to fit and remove a tyre on a wheel rim will now be described with reference to the illustrated embodiment.

Without the use of a tool such a tyre lever, when fitting a tyre on a wheel rim, the user can typically lift a tyre over the wheel rim wall so that a first side wall of the tyre is received by the channel of the wheel rim. A portion of the second side wall of the tyre may also be lifted over the wheel rim without the use of the tool, such that the second side wall of the tyre is partly received by the channel of the wheel rim. However, without the use of a tool, it may not be possible to lift the remaining portion of the second side wall over the wheel rim wall, due to inflexibility and/or tightness of the tyre. At that point, a tool typically must be employed.

Referring to FIG. 5, once the tool 100 is positioned in place, i.e. with the channel 4 over the wheel rim, in use, the tyre-engagement portion 2 may engage the side wall of the tyre to fit the tyre into the channel of the wheel rim, over the wheel rim wall. The tyre-engagement portion 2 may guide the uninstalled portion of the side wall towards the wheel rim. In an example, the user moves the tool 100 around the wheel rim circumferentially, while maintaining the wheel rim side wall in the channel 4, thereby enabling the tyre bead and the side wall of the uninstalled tyre portion to ease over the wall of the wheel rim. Importantly, due to the fact that the hook portion of the tool is orthogonal to the longitudinal axis of the elongate body, when installing the tyre on a wheel rim, the tool 100 remains at substantially 90 degrees to the tyre, preventing the user from hitting their hands on the wheel spokes.

In order to remove the tyre from the wheel rim, the user may push the hook portion 3 underneath part of a tyre bead on one of the side walls of the tyre so that the tyre bead is lifted and the hook portion 3 is located between the tyre bead and the wheel rim. In other words, during removal of the tyre from the wheel rim, the hook portion 3 may be located behind a side wall of the tyre. As discussed above, the tool 100 may be kept in place due to presence of the protrusion 3a, which sits on top of the wheel rim. During removal of the tyre, the tool 100 remains at substantially 90 degrees to the tyre, preventing the user from hitting their hands on the wheel spokes, due to the fact that the hook portion of the tool is orthogonal to the longitudinal axis of the elongate body.

As the hook portion 3 points to a direction opposite to the wheel rim, positioning the hook portion 3 underneath the tyre bead further lifts the tyre bead over and away from the wheel rim, as depicted in FIG. 6. The tool 100 may then be moved circumferentially around the wheel rim until all of the tyre side wall has been removed from the wheel rim, or until enough of the tyre side wall has been removed for a user to continue to remove the tyre without the use of the tool. The tool may be moved circumferentially in either rotational direction to achieve this.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims in determining the scope of the instant disclosure.

1. A tool for fitting and removing a tyre on a wheel rim, the tool comprising:
an elongate body forming a handle for the tool, the elongate body having a plane and a longitudinal axis;
a tyre-engagement portion arranged to, in use, engage with an outer side wall of the tyre to thereby facilitate fitting of the tyre, the tyre-engagement portion having a plane which is co-planar with the plane of the elongate body; and
a hook portion, orthogonal to the longitudinal axis of the elongate body, arranged to, in use, engage with an inner side wall of the tyre to thereby facilitate removal of the tyre.

2. The tool of claim 1, wherein the hook portion further comprises a protrusion located at a rear portion of the hook portion, the protrusion arranged to, in use, engage with a side wall of the wheel rim to thereby keep the tool in place during removal of the tyre.

3. The tool of claim 1, further comprising a channel formed in a lateral axis of the elongate body, the channel arranged to, in use, receive a side wall of the wheel rim.

4. The tool of claim 3, wherein the channel further comprises a lip arranged to, in use, engage with an inner section of the side wall of the wheel rim.

5. The tool of claim 1, wherein the tyre-engagement portion comprises a substantially flat surface.

6. The tool of claim 1, wherein the elongate body comprises an aperture.

7. The tool of claim 1, wherein the elongate body comprises a plurality of structural support elements.

8. The tool of claim 1, wherein the elongate body is generally planar in form.

9. The tool of claim 1 further comprising a second hook portion orthogonal to the longitudinal axis of the elongate body.

10. A method for removing a tyre from a wheel rim using the tool according to claim 1, the method comprising:
pushing the hook portion underneath part of a tyre bead so that the tyre bead is lifted and the hook portion is located between the tyre bead and the wheel rim; and
moving the tool circumferentially around the wheel rim to thereby remove the tyre,
wherein, during the removal, the tool is arranged at substantially 90 degrees to the tyre.

11. A method for fitting a tyre on a wheel rim using the tool according to claim 1, the method comprising:
placing the tyre over a wheel rim wall so that a first side wall of the tyre is whole seated in a channel of the wheel rim;
positioning the tool over the wheel rim wall such that the tyre-engagement portion engages a second side wall of the tyre; and
moving the tool circumferentially around the wheel rim to thereby fit the second side wall of the tyre in the channel of the wheel rim,
wherein, during the fitting, the tool is arranged at substantially 90 degrees to the tyre.
